(19) United States
(12) Patent Application Publication
(10) Pub. No.: US 2023/0278449 A1
(43) Pub. Date: Sep. 7, 2023

(54) SYSTEMS AND METHODS FOR CLIMATE CONTROL OF AN ELECTRIC VEHICLE

(71) Applicant: Volta Charging, LLC, San Francisco, CA (US)

(72) Inventors: Jeffrey Kinsey, San Mateo, CA (US); Ramsey Meyer, San Francisco, CA (US); Michael Clement, Monterey, CA (US)

(21) Appl. No.: 17/970,114

(22) Filed: Oct. 20, 2022

Related U.S. Application Data
(60) Provisional application No. 63/270,705, filed on Oct. 22, 2021.

(51) Int. Cl. B60L 53/64; B60H 1/00

(52) U.S. Cl. CPC B60L 53/64; B60H 1/00285; B60H 1/00292; B60H 1/00385; B60H 1/00878; B60H 1/00778

(57) ABSTRACT

Systems and method for charging the battery of an electric vehicle (EV) and climatically controlling the inside cabin of the electric vehicle are described. The methods include detecting that an EV is electrically connected to a charging station and then determining the current temperature inside the EV. Climatic user preferences can be retrieved and used to determine a desired climate inside the cabin when the user returns to the vehicle. Using the desired climate inside the cabin to determine an estimated charge, where the estimated charge is sufficient to both obtain the desired climate inside the cabin by the time the users return and have the battery of the vehicle charged to an acceptable level.

### BACKGROUND

The present disclosure relates to computer-implemented techniques for charging electric vehicles and climatically balancing their climatic environment to a desired setting, and in particular to techniques for allocating resources to electric vehicles based on information corresponding to an inferred dwell time and the time of user’s return to the electric vehicle.

### SUMMARY

As more consumers transition to electric vehicles, there is an increasing demand for electric vehicle charging stations (EVCSs) to charge the battery of the electric vehicle as well as climatically balance the interior cabin of the electric vehicle to a desired climatic setting. These EVCSs usually supply electric energy, either using cables or wirelessly, to the batteries of electric vehicles. For example, a user can connect their electric vehicle via cables of an EVCS, and the EVCS supplies an electrical current to the user’s electric vehicle. The cables and control systems of the EVCSs can be housed in kiosks in locations that allow a driver of an electric vehicle to park the electric vehicle close to the EVCS and begin the charging process. These kiosks may be placed in areas of convenience, such as in parking lots at shopping centers, in front of commercial buildings, or in other public places. These kiosks often comprise a display that can be used to provide media items to the user to enhance the user’s charging experience. Consequently, passers-by, in addition to users of the EVCS, may notice media items displayed by the EVCS. Traditionally, EVCSs provide the same services (e.g., charging rate, charging cost, user experience, etc.) to each electric vehicle that is connected to the EVCSs without considering additional factors (e.g., inferred dwell time, electrical grid load, vehicle information, etc.), which results in inefficient electric vehicle charging. These traditional services also do not provide any services that climatically balance the electric vehicle to a desired climatic setting.

As such, in some embodiments, methods and systems are described that charge the battery of the electric vehicle and climatically balance the cabin, as well as certain external features, of the electric vehicle to a desired user setting.

In some embodiments, the control circuitry determines the cabin temperature of the electric vehicle and determines the desired temperature at the end of dwell time, i.e., the time a user would return to the electric vehicle. In some applications, dwell time can be calculated using one or more factors, such as U.S. Application No. 63/177,787, the entire disclosure of which is hereby incorporated by reference herein in its entirety. The control circuitry accesses a user profile to determine the user’s preferred climate settings. In another embodiment, the control circuitry records temperature control settings from previous rides taken in the electric vehicle to detect a pattern and determine a climate preference for the user.

Based on the user’s preferences, the control circuitry determines the amount of charge needed during dwell time to both charge the battery as well as reach the desired temperature by the end of dwell time. In some embodiments, the control circuitry determines a plurality of charging options to reach the desired temperature. These charging options consider cost of charging and battery lifespan preservation. The charging options also determine peak time periods to select a charging option that minimizes charging during peak time periods. Charging options may also include charging the electric vehicle to the full desired amount of charge or charging it to a predefined amount of charge such as 15 kWh, and then stopping charging.

In determining a charging option, the control circuitry considers surrounding conditions, weather forecast, parking pattern recognition, and user recognition. Surrounding conditions include determining exposure to sunlight and amount of shade on the electric vehicle to predict the temperature that will be reached by the cabin of the electric vehicle based on the surrounding conditions. In some embodiments, the control circuitry uses weather sensors (e.g., thermometers, barometers, light sensors, etc.) located on the EVCS to determine the surrounding conditions. Weather forecasts are also considered in making climatically balancing decisions. In some embodiments, the weather forecast is received at the EVCS via an Internet connection. In some embodiments, if the weather forecast calls for an increased or decreased temperature, the control circuitry may calculate and predict the interior temperature of the cabin resulting from the outside increase or decrease in temperature to determine the amount of charge needed to accommodate for the weather change.

In some embodiments, the control circuitry, using the electric vehicle’s global positioning system (GPS) may determine the parking location of the electric vehicle and determine that the parking location forms a parking pattern where the user usually parks their electric vehicle to charge the battery. The control circuitry may consider factors surrounding the usual parking spot to determine and recommend climate control settings. For example, based on the parking pattern, i.e., parking of the electric vehicle in the same spot, the control circuitry may recognize that the electric vehicle is parked inside a covered parking garage that has a cooler temperature than the outside uncovered parking areas. The control circuitry may factor in such information to calculate and predict the interior cabin temperature over the dwell time based on the cooler garage temperature and accordingly select a charging option. In some embodiments, the location and/or physical condition of the EVCS may be recorded at the time of installation. For example, at the time of installation, an EVCS in a parking garage may be programmed as a shaded EVCS and may use this programing to determine and/or recommend a climatic setting for the electric vehicle.

In some embodiments, the control circuitry may consider the cost, surrounding factors, weather forecast, dwell time, peak times and hours, and desired climatic settings, to activate heating or cooling hardware within the electric vehicle to heat or cool the interior cabin to the user’s desired climatic preference. The control circuitry may heat or cool the entire interior cabin or selective zones within the interior cabin. The control circuitry may also heat or cool one or more seats of the electric vehicle. It may also heat or cool the steering wheel. The control circuitry may also defrost the side-view mirrors or the front and rear windshield. The control circuitry may detect precipitation on the windshield and turn on windshield wipers as needed.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for charging an electric vehicle and providing desired climate control based on an inferred dwell time of a user of the electric vehicle, in accordance with some embodiments of the disclosure;

FIGS. 2A-2F show a process for determining an estimated dwell time to climatically balance an electric vehicle, in accordance with some embodiments of the disclosure;

FIGS. 3A and 3B illustrate an EVCS used for charging an electric vehicle and climatically balancing it to a desired setting based on the inferred dwell time of a user of the electric vehicle, in accordance with some embodiments of the disclosure;

FIG. 4 shows an illustrative block diagram of an EVCS system, in accordance with some embodiments of the disclosure;

FIG. 5 shows an illustrative block diagram of a user equipment device system, in accordance with some embodiments of the disclosure;

FIG. 6 shows an illustrative block diagram of a server system, in accordance with some embodiments of the disclosure;

FIG. 7 is an illustrative flowchart of a process for climatically balancing the electric vehicle based on the inferred dwell time and the return time of a user to the electric vehicle, in accordance with some embodiments of the disclosure;

FIG. 8 is another flowchart of a process for climatically balancing the electric vehicle while managing charging rates, in accordance with some embodiments of the disclosure;

FIG. 9 is a block diagram of some of the factors considered in climatically balancing the electric vehicle, in accordance with some embodiments of the disclosure;

FIG. 10 is an exemplary figure depicting the effect of parking location on balancing the electric vehicle climatically, in accordance with some embodiments of the disclosure;

FIG. 11 is a flowchart of a process for climatically balancing by utilizing the weather forecast, in accordance with some embodiments of the disclosure;

FIG. 12 is a table depicting exemplary charging costs and duration for charging the electric vehicle’s battery and climatically balancing the electric vehicle, in accordance with some embodiments of the disclosure;

FIG. 13 is a table depicting exemplary charging costs during peak and non-peak charging times and adjusting the charging schedule based on the dwell time to provide options to the user of the electric vehicle, in accordance with some embodiments of the disclosure;

FIG. 14 is a block diagram of some of heating and cooling zones that may be climatically balanced, in accordance with some embodiments of the disclosure; and

FIG. 15 illustrates an EVCS comprising a step-down transformer charging an electric vehicle, in accordance with some embodiments of the disclosure.

### DETAILED DESCRIPTION

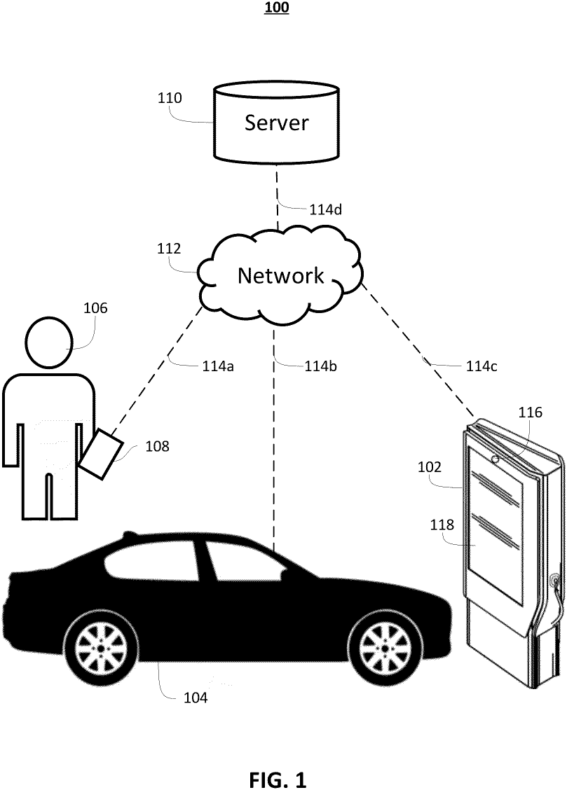

FIG. 1 shows an illustrative diagram of a system 100 for charging an electric vehicle 104 and climatically controlling the electric vehicle based on an inferred dwell time of a user 106 of the electric vehicle, in accordance with some embodiments of the disclosure. In some embodiments, the EVCS 102 provides an electric charge to the electric vehicle 104 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, and/or electric vehicles, so that the items may communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communication network path comprises one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communication network path can be a wireless path. Communications with the devices may be provided by one or more communication paths but is shown as a single path in FIG. 1 to avoid overcomplicating the drawing.

In some embodiments, the EVCS 102 infers a dwell time related to the user 106 of the electric vehicle 104 using user information (e.g., user location, user calendars, user purchases, user patterns, etc.). In some embodiments, to infer a dwell time using user information the EVCS 102 determines a user 106 associated with the electric vehicle 104. In some embodiments, the user 106 may have to present some credentials (e.g., password, pin, biometrics, device, item, etc.) when requesting the EVCS 102 to charge their electric vehicle 104. For example, the user 106 may enter a password on the display 118 of the EVCS 102. In another example, the user 106 may enter a biometric password (e.g., fingerprint) on the user device 108, which is then communicated to the EVCS 102 and/or the server 110 via the network 112. In some embodiments, the credentials may be automatically inputted. For example, the user device 108 may automatically transmit user credentials to the EVCS 102 when the user device 108 is within a threshold distance of the EVCS 102. In some embodiments, the EVCS 102 uses characteristics of the electric vehicle 104 as credentials. For example, the EVCS 102 may automatically obtain characteristics of the electric vehicle 104 using ISO 15118 when the user 106 plugs in their electric vehicle 104. In some embodiments, the EVCS 102 uses the credentials to identify a user profile associated with the user 106. For example, the EVCS 102 may access a database (e.g., located on server 110) that associates credentials with a user profile. In some embodiments, the user profile stores information about the user 106. For example, the user profile may store user information related to the user 106, vehicle information of the electric vehicle 104 related to the user 106, and/or similar such information. The database may also store in the user profile preferred temperature and climatic settings of a user, such as the user prefers the electric vehicle to be at 75° F. during summer and at 65° F. during winter or that the user prefers heated seats and heated steering wheel when the outside temperature reaches a level, etc. The database may also store separate temperature and climatic preferences for separate users of the electric vehicle, such as each family member or colleague that will be using the electric vehicle.

In some embodiments, the EVCS 102 uses user information obtained from the user profile to determine an estimated charge time for the electric vehicle 104 and an estimated charge needed to climatically balance the electric vehicle to the user’s desired settings. In some embodiments, EVCS 102 retrieves a first piece of user information (e.g., the user 106 purchasing a movie ticket for a two-hour movie) indicating that the user 106 will be within a first vicinity (e.g., near the EVCS 102) for an estimated amount of time. In some embodiments, the EVCS 102 uses the estimated dwell time that a user will be within a first vicinity to determine an estimated charge time for the electric vehicle 104. In some embodiments, the EVCS 102 determines a charging rate for the electric vehicle 104 based on the estimated charge time. For example, a slower charging rate may be used for longer estimated charge times (e.g., two hours) and a faster charging rate may be used for shorter estimated charge times (e.g., 15 minutes). Accordingly, an electric vehicle is not subject to unnecessarily fast charging rates, resulting in a prolonged lifespan of the vehicle’s battery.

In some embodiments, the EVCS 102 uses characteristics of the electric vehicle 104 to determine the user 106 associated with the electric vehicle 104. In some embodiments, the EVCS 102 uses one or more sensors to capture information about the electric vehicle 104. For example, these sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, one or more cameras 116 are configured to capture one or more images of an area proximal to the EVCS 102. For example, a camera may be configured to obtain a video or capture images of an area corresponding to a parking spot associated with the EVCS 102, a parking spot next to the parking spot of the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at different locations on the EVCS 102 than what is shown. In some embodiments, the camera 116 works in conjunction with other sensors. In some embodiments, the one or more sensors (e.g., camera 116) can detect external objects within a region (area) proximal to the EVCS 102. In some embodiments, the one or more sensors are configured to determine a state of the area proximal to the EVCS 102. In some embodiments, the state may correspond to detecting external objects, detecting the lack of external objects, etc. In some embodiments, the external objects may be living or nonliving, such as people, animals, vehicles, shopping carts, toys, etc.

In some embodiments, after the one or more sensors capture information, the EVCS 102 can use this information to determine the electric vehicle’s 104 characteristics (e.g., model, make, specifications, condition, etc.). In some embodiments, using the data collected from the one or more sensors, the EVCS 102 can identify electric vehicle characteristics by leveraging machine learning. The EVCS 102 can use the determined electric vehicle characteristics to determine the user 106 associated with the electric vehicle 104. For example, the EVCS 102 can receive an image of the license plate (e.g., information captured by the one or more sensors) of the electric vehicle 104 from the camera 116. In some embodiments, the EVCS 102 reads the license plate (e.g., using optical character recognition) and uses the license plate information (e.g., electric vehicle characteristic) to determine the user 106 associated with the electric vehicle 104. In some embodiments, the EVCS 102 uses a database to look up user information and/or additional vehicle characteristics of the electric vehicle 104 using the license plate information. For example, the database may comprise public records (e.g., public registration information linking license plates to vehicle characteristics), collected information (e.g., entries linking license plates to vehicle characteristics based on data inputted by a user), historic information (entries linking license plates to vehicle characteristics based on the EVCS 102 identifying vehicle characteristics related to one or more license plates in the past), and/or similar such information.

In some embodiments, the EVCS 102 uses information captured from the one or more sensors to determine vehicle characteristics of the electric vehicle 104, and/or to determine the user 106 associated with the electric vehicle 104. In some embodiments, upon connection, the EVCS 102 receives a media access control (MAC) address from the electric vehicle 104 and the EVCS 102 uses the MAC address to determine vehicle characteristics of the electric vehicle 104 and/or to determine the user 106 associated with the electric vehicle 104. The EVCS 102 can use a database to match the received MAC address or portions of the received MAC address to entries in the database to determine vehicle characteristics of the electric vehicle 104. For example, certain vehicle manufacturers keep portions of their produced electric vehicle’s MAC addresses consistent. Accordingly, if the EVCS 102 determines that a portion of the MAC address received from the electric vehicle 104 corresponds to an electric vehicle manufacturer, the EVCS 102 can determine vehicle characteristics of the electric vehicle 104. The EVCS 102 can also use a database to match the received MAC address or portions of the received MAC address to entries in the database to determine the user 106 associated with the electric vehicle 104. For example, the electric vehicle’s MAC address may correspond to a user profile corresponding to the user 106 associated with the electric vehicle 104. Separate MAC addresses for different members of a family or company using the electric vehicle may be stored in a database.

In some embodiments, the EVCS 102 uses user information to determine vehicle characteristics of the electric vehicle 104. For example, the user 106 may input vehicle characteristics into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106.

In some embodiments, the EVCS 102 can use the information captured by the one or more sensors to determine an estimated charge time. For example, the one or more sensors may determine that the electric vehicle’s battery is 20% charged. Based on this information, the EVCS 102 can determine an estimated charge time (e.g., one hour) to both charge the vehicle and climatically balance the electric vehicle to a user-desired climatic setting. The EVCS 102 may determine the estimated charge time based on accessing a database where battery percentages correspond to estimated charge times. In some embodiments, the estimated charge time can be used in conjunction with and/or derived from information captured by the one or more other sensors. For example, using the camera 116, the EVCS 102 can determine the make and model of the electric vehicle 104, and a battery sensor can determine the battery percentage of the electric vehicle 104. The EVCS 102 can then access a database to determine the estimated charge time when using an optimal charging rate given the make, model, and battery percentage of the electric vehicle 104.

In some embodiments, the EVCS 102 determines an estimated charge time for the electric vehicle 104 to both charge the battery as well as climatically balance the electric vehicle to a desired setting and uses the estimated charge time to customize media displayed by the display 118. For example, if the estimated charge time of the electric vehicle 104 is a longer timeframe, the EVCS 102 can determine that a first media item (e.g., movie ticket sale) may be more desirable to the user 102 of the electric vehicle 104 because the first media item corresponds to an activity with a longer timeframe. If the estimated charge time of the electric vehicle 104 is a shorter timeframe, the EVCS 102 can determine that a second media item (e.g., coffee sale) may be more desirable to the user 102 of the electric vehicle 104 because the second media item corresponds to an activity that can be completed more quickly. In some embodiments, the EVCS 102 customizes media to display based on other vehicle characteristics. For example, the EVCS 102 can determine the depth of the tire tread of the electric vehicle 104 using the one or more sensors and customize media items based on the condition of the tire tread. If the EVCS 102 determines that the tire tread is too shallow, EVCS 102 can display media items (e.g., tire tread notification, tire sales, etc.) relating to the tire tread condition.

In some embodiments, the EVCS 102 determines an inferred dwell time for the user 106 and uses the inferred dwell time to customize media displayed by the display 118. For example, if the inferred dwell time is a longer timeframe, the EVCS 102 can determine that a first media item (e.g., movie ticket sale) may be more desirable to the user 102 of the electric vehicle 104 because the first media item corresponds to an activity with a longer timeframe. If the inferred dwell time is a shorter timeframe, the EVCS 102 can determine that a second media item (e.g., coffee sale) may be more desirable to the user 102 of the electric vehicle 104 because the second media item corresponds to an activity that can be completed more quickly. In some embodiments, EVCS 102 uses the inferred dwell time to customize media displayed by the display 118 to passers-by. For example, if the inferred dwell time is a longer timeframe, the EVCS 102 can determine that the user 106 will not be viewing the display 118 for a majority of the timeframe. In some embodiments, the EVCS 102 prioritizes a third media item (e.g., charging price sales), wherein the third media item is selected based on passers-by rather than the user 106.

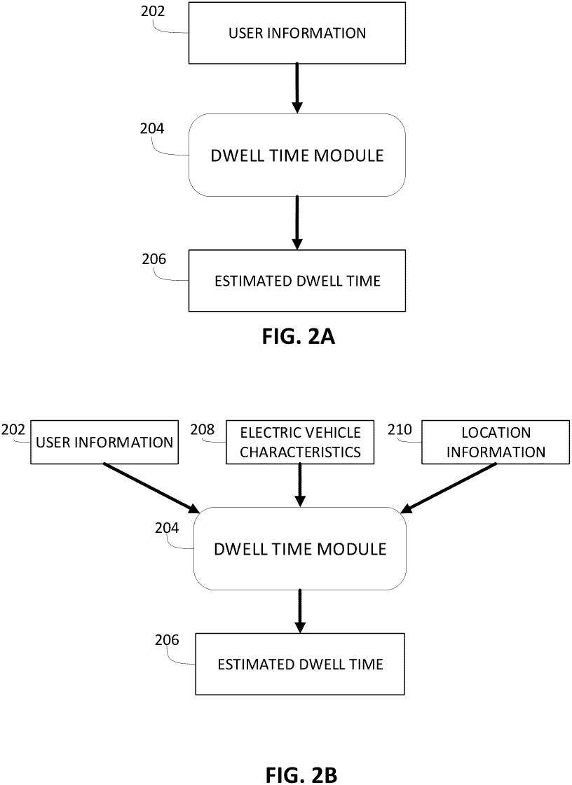

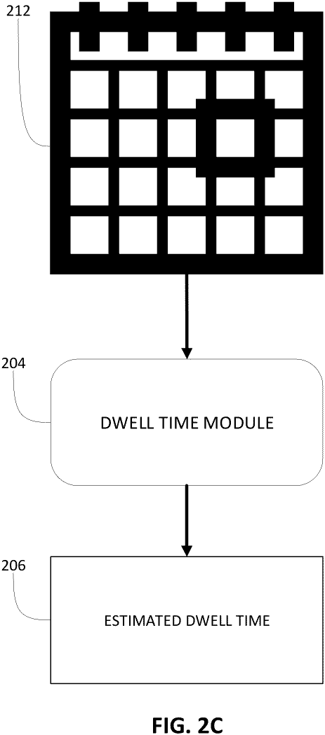

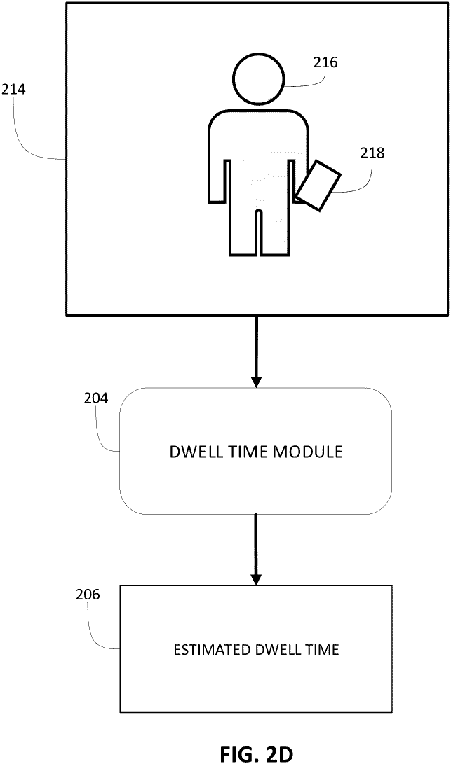

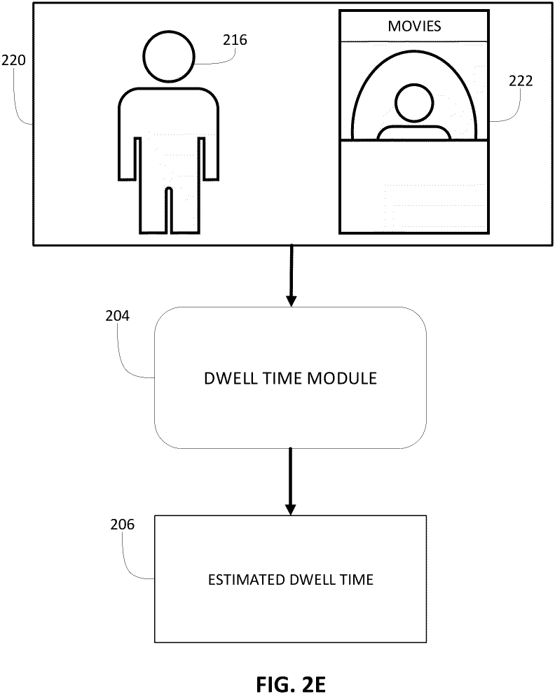

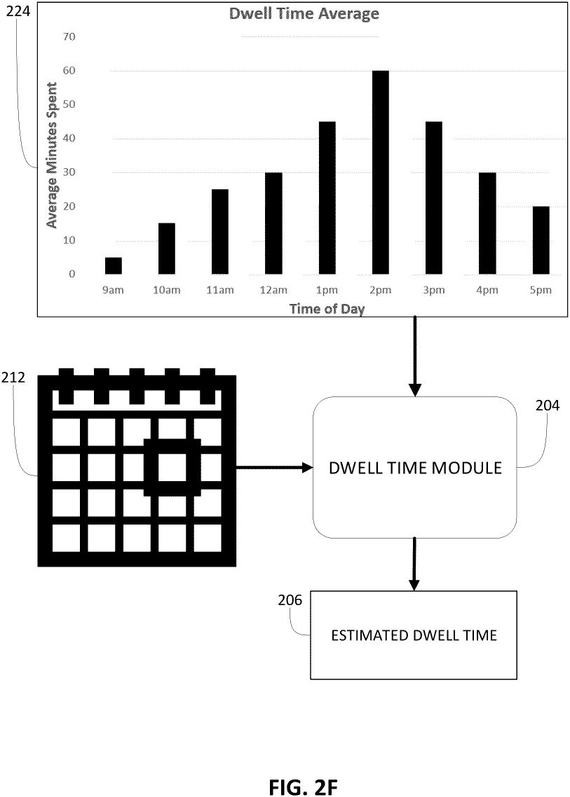

FIGS. 2A-2F show an illustrative process for determining a charging rate for an electric vehicle to charge its battery and climatically balance it, in accordance with some embodiments of the disclosure. In some embodiments, FIGS. 2A-F use the same of similar methods and devices described in FIG. 1.

FIG. 2A shows a dwell time module 204 receiving user information 202 and outputting an estimated dwell time 206. As described herein, the dwell time module 204 may be located in an EVCS (e.g., EVCS 102), a server (e.g., server 110), a user device (e.g., user device 108) or any combination thereof. As described above, the estimated dwell time 206 relates to the estimated amount of time that a user (e.g., user 106) will be within a first vicinity, which relates to the amount of time that the user’s electric vehicle (e.g., electric vehicle 104) will be charging at an EVCS (e.g., EVCS 102) to charge the battery and climatically balance the electric vehicle to a desired climatic setting.

In some embodiments, to determine the estimated dwell time 206, the dwell time module 204 uses user information 202 (e.g., user location, user calendars, user purchases, user patterns, etc.). The dwell time module 204 has a variety of methods of obtaining the user information 202 (e.g., receiving the user information 202 from a database, receiving the user information 202 from a user, receiving the user information 202 from a third-party provider, etc.). The dwell time module 204 can use one piece of user information 202 or a plurality of user information to determine the estimated dwell time 206. In some embodiments, different user information is weighted according to significance. For example, a first piece of user information indicating that the user has an upcoming event may be weighted higher than a second piece of user information indicating that the user made a purchase two weeks ago. Accordingly, the dwell time module 204 will use the different weights in determining an estimated dwell time 206 of the user. In some embodiments, the dwell time module 204 outputs the estimated dwell time 206 to an EVCS (e.g., EVCS 102), a server (e.g., server 110), a user device (e.g., user device 108) or any combination thereof. In some embodiments, the estimated dwell time is used to determine an estimated charge time and/or a charging rate for an electric vehicle to charge the battery as well as climatically balance the electric vehicle to a user-desired climatic setting. In some embodiments, the dwell time module 204 uses the estimated dwell time 206 to determine an estimated charge time for an electric vehicle to charge the battery as well as climatically balance the electric vehicle to a user-desired climatic setting. In some embodiments, the dwell time module 204 uses the estimated dwell time 206 and/or the estimated charge time to determine a charging rate to charge an electric vehicle to charge the battery as well as climatically balance the electric vehicle to a user-desired climatic setting.

FIG. 2B shows a dwell time module 204 receiving user information 202, electric vehicle characteristics 208, and location information 210 and outputting an estimated dwell time 206. In some embodiments, FIG. 2B generates an estimated dwell time 206 in the same or similar way as described above in FIG. 2A. In some embodiments, the dwell time module 204 uses any combination of user information 202, electric vehicle characteristics 208, location information 210, and similar such information to determine the estimated dwell time 206. In some embodiments, the dwell time module 204 receives only the user information 202 and the electric vehicle characteristics 208 and determines the estimated dwell time 206. In some embodiments, the dwell time module 204 receives only the user information 202 and the location information 210 and determines the estimated dwell time 206. The dwell time module 204 can use one or more pieces of user information 202, electric vehicle characteristics 208, and/or location information 210 to determine the estimated dwell time 206. In some embodiments, the dwell time module 204 uses the estimated dwell time 206 and/or the estimated charge time to determine a charging rate to charge an electric vehicle to charge the battery as well as climatically balance the electric vehicle to a user-desired climatic setting. In some embodiments, the dwell time module 204 uses one or more pieces of information to determine the estimated dwell time and then uses a different one or more pieces of information to determine the estimated charge time and/or charging rate of an electric vehicle to charge the battery as well as climatically balance the electric vehicle to a user-desired climatic setting. For example, the dwell time module 204 can use the user information 202 to determine the estimated dwell time 206 and can use the estimated dwell time 206 and electric vehicle characteristics 208 to determine the estimated charge time to charge the battery as well as climatically balance the electric vehicle to a user-desired climatic setting. In some embodiments, the dwell time module 204 uses one or more pieces of information to determine the estimated dwell time and then uses the same one or more pieces of information to determine the estimated charge time and/or charging rate of an electric vehicle. For example, the dwell time module 204 can use the user information 202 and location information 210 to determine the estimated dwell time 206 and can then use the estimated dwell time 206, user information 202, and location information 210 to determine the estimated charge time to charge the battery as well as climatically balance the electric vehicle to a user-desired climatic setting.

FIG. 2C shows an embodiment of a dwell time module 204 receiving a user’s calendar information 212 (user information) and outputting an estimated dwell time 206 for a user. The dwell time module 204 can use the user’s calendar information 212 to determine an estimated dwell time 206 to charge the battery as well as climatically balance the electric vehicle to a user-desired climatic setting. For example, the user may request an EVCS to start charging their electric vehicle at 1:00 PM and the dwell time module 204 may receive a user’s calendar information 212 indicating that the user has an event, located within the vicinity of the EVCS, ending at 3:00 PM. The dwell time module 204 can use the user’s calendar information 212 to determine that the estimated dwell time 206 is approximately two hours. In some embodiments, the dwell time module 204 can also determine an estimated charge time and/or charging rate for the electric vehicle of the user to charge the battery as well as climatically balance the electric vehicle to a user-desired climatic setting. For example, a slower charging rate may be used for longer estimated dwell times (e.g., two hours) and a faster charging rate may be used for shorter estimated dwell times (e.g., 15 minutes). Accordingly, an electric vehicle is not subject to unnecessarily fast charging rates, resulting in a prolonged lifespan of the vehicle’s battery.

FIG. 2D shows an embodiment of a dwell time module 204 receiving a geofence notification (user information) and outputting an estimated dwell time 206 for a user 216. The dwell time module 204 can use the geofence notification to determine an estimated dwell time 206. For example, the user 216 may request an EVCS to start charging their electric vehicle at 1:00 PM and the dwell time module 204 may receive a geofence notification indicating that a device 218 associated with the user 216 crossed a geofence 214 at 1:05 PM. The dwell time module 204 can use the geofence notification to determine an estimated dwell time (e.g., 15 minutes) based on the amount of time that the user spent in the location related to the geofence 214 in the past. For example, the dwell time module 204 may receive past user behavior patterns indicating that the user 216 spent an average amount of time (e.g., 15 minutes) in the location related to the geofence 214. In some embodiments, the location related to the geofence 214 may correspond to an estimated dwell time (e.g., coffee shops correspond to 15 minutes, movie theaters correspond to two hours, etc.). In some embodiments, the dwell time module 204 can also determine an estimated charge time and/or charging rate for the electric vehicle of the user based on the estimated dwell time 206 to charge the battery as well as climatically balance the electric vehicle to a user-desired climatic setting. For example, a slower charging rate may be used for longer estimated dwell times (e.g., two hours), and a faster charging rate may be used for shorter estimated dwell times (e.g., 15 minutes). Accordingly, an electric vehicle is not subject to unnecessarily fast charging rates, resulting in a prolonged lifespan of the vehicle’s battery.

FIG. 2E shows an embodiment of a dwell time module 204 receiving a purchase notification 220 (user information) and outputting an estimated dwell time 206 for a user 216. The dwell time module 204 can use the purchase notification 220 to determine an estimated dwell time 206. For example, the user 216 may request the EVCS to start charging their electric vehicle at 1:00 PM, and the dwell time module 204 may retrieve a purchase notification indicating that the user 216 purchased a movie ticket 222 for a movie ending at 3:00 PM. The dwell time module 204 can use the purchase notification 220 to determine that the estimated dwell time 206 will be approximately two hours. In some embodiments, the dwell time module 204 can also determine an estimated charge time and/or charging rate for the electric vehicle of the user based on the estimated dwell time 206 to charge the battery as well as climatically balance the electric vehicle to a user-desired climatic setting. For example, a slower charging rate may be used for longer estimated charge times (e.g., two hours) and a faster charging rate may be used for shorter estimated charge times (e.g., 15 minutes). Accordingly, an electric vehicle is not subject to unnecessarily fast charging rates, resulting in a prolonged lifespan of the vehicle’s battery.

FIG. 2F shows an embodiment of a dwell time module 204 receiving a user’s calendar information 212 (user information) and location trends 224 (location information) and outputting an estimated dwell time 206 for a user. In some embodiments, the dwell time module 204 can use the user’s calendar information 212 and location trends 224 to determine an estimated dwell time 206. For example, the user may request an EVCS to start charging their electric vehicle at 1:00 PM, and the dwell time module 204 may receive a user’s calendar information 212 indicating that the user has an event (e.g., getting a haircut) occurring at a location. In some embodiments, the user’s calendar information 212 is ambiguous on the end time for the event. The dwell time module 204 may also receive locations trends 224 comprising the dwelling trends of the location. In some embodiments, the dwelling trends can relate to amount of time users normally spend in the location. For example, users may spend different amounts of time in different locations (e.g., average of 10 minutes in coffee shops, average of two hours in restaurants, etc.). In some embodiments, the dwell trends indicate that the average dwell time changes depending on other factors (e.g., time of day, day of the week, season, temperature, traffic, etc.). The dwell time module 204 can use the user’s calendar information 212 and location trends 224 to determine that the estimated dwell time 206 will be approximately 45 minutes at 1:00 PM. In some embodiments, the dwell time module 204 can also determine an estimated charge time and/or charging rate for the electric vehicle of the user based on the estimated dwell time 206 to charge the battery as well as climatically balance the electric vehicle to a user-desired climatic setting. For example, a slower charging rate may be used for longer estimated charge times (e.g., two hours) and a faster charging rate may be used for shorter estimated charge times (e.g., 15 minutes). Accordingly, an electric vehicle is not subject to unnecessarily fast charging rates, resulting in a prolonged lifespan of the vehicle’s battery.

In some embodiments, the estimated dwell time 206 is used to customize media items to display to the users of the electric vehicles. For example, the dwell time module 204 can determine that a first estimated dwell time for a first electric vehicle will be longer than a second estimated dwell time for a second electric vehicle. In some embodiments, an EVCS, server, and/or user device determines that a first media item (e.g., movie ticket sale) may be more desirable to the user of the first electric vehicle because the first media item corresponds to an activity with a timeframe similar to the first estimated dwell time. In some embodiments, this determination is made using a database that contains entries where media items correspond to estimated dwell times.

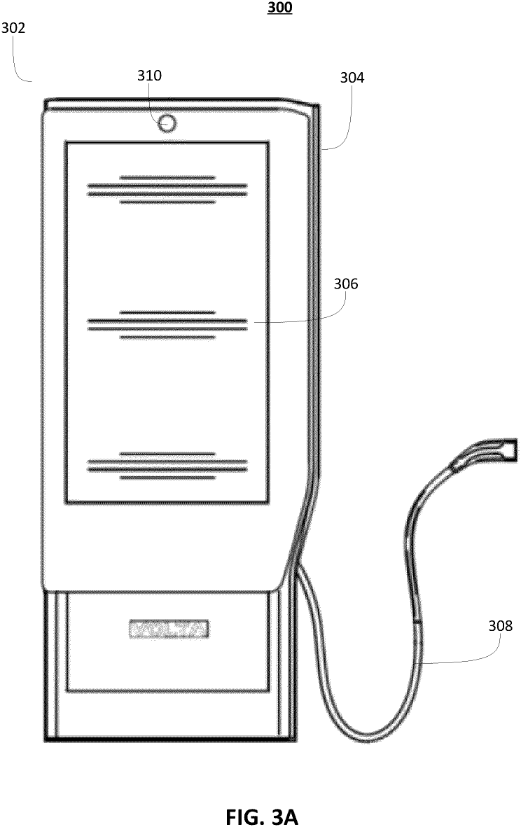

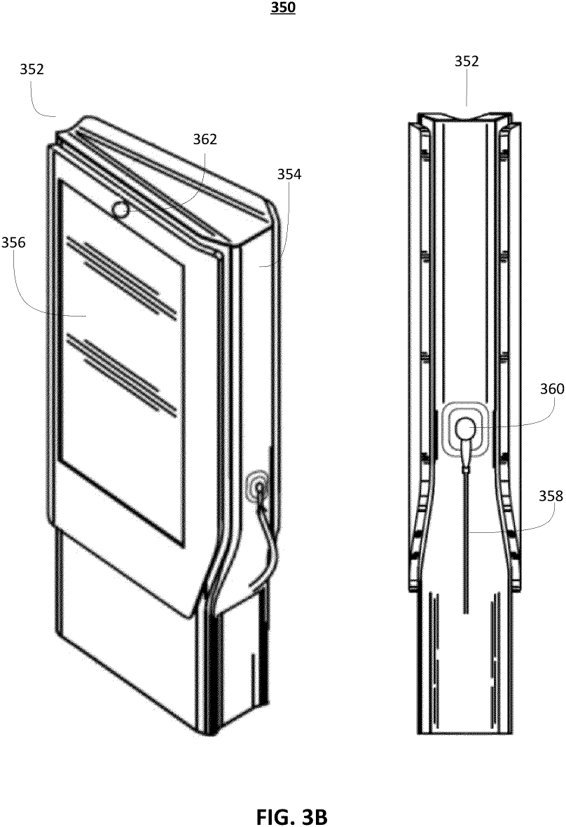

FIG. 3A illustrates an EVCS used for charging the battery as well as climatically balancing the electric vehicle to a user-desired climatic setting based on the inferred dwell time of the user of the electric vehicle, in accordance with some embodiments of the disclosure. In some embodiments, FIG. 3A illustrates the EVCS displayed in FIG. 1. EVCS 302 includes a housing 304 (e.g., a body or a chassis) that holds a display 306. In some embodiments, EVCS 302 comprises more than one display. For example, EVCS 302 may have a first display 306 and a second display (on the other side of EVCS 302). In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicles) and/or to passersby that are in proximity to the EVCS 302. In some embodiments, the display 306 has a height that is at least three feet and a width that is at least two feet.

EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes a near-field communication (NFC) system that is configured to interact with a user’s device (e.g., user device 108 of a user 106 in FIG. 1).

EVCS 302 further comprises a charging cable 308 (e.g., connector) configured to connect and provide a charge to an electric vehicle (e.g., electric vehicle 104 of FIG. 1). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. For example, in some embodiments, the housing 304 includes power supply circuitry as well as circuitry for determining a state of a vehicle being charged (e.g., whether the vehicle is connected via the connector, whether the vehicle is charging, whether the vehicle is done charging, etc.). In some embodiments, EVCS 302 supports ISO 15118, which allows a user to plug their electric vehicle into EVCS 302 and begin charging without inputting any additional information. ISO 15118 is a communication interface, which, among other things, can identify the make and model of an electric vehicle to an EVCS. When an electric vehicle that supports ISO 15118 begins charging, EVCS 302 can receive vehicle characteristics (e.g., make and model of the electric vehicle) using ISO 15118.

EVCS 302 further comprises one or more cameras 310 configured to capture one or more images of an area proximal to EVCS 302. In some embodiments, the one or more cameras 310 are configured to obtain video of an area proximal to the EVCS 302. For example, a camera may be configured to obtain a video or capture images of an area corresponding to a parking spot associated with EVCS 302. In another example, another camera may be configured to obtain a video or capture images of an area corresponding to a parking spot next to the parking spot of EVCS 302. In some embodiments, the camera 310 may be a wide-angle camera or a 360° camera that is configured to obtain a video or capture images of a large area proximal to EVCS 302. The one or more cameras 310 may be mounted directly on the housing 304 of EVCS 302 and may have a physical (e.g., electrical, wired) connection to EVCS 302 or a computer system associated with EVCS 302. In some embodiments, the one or more cameras 310 (or other sensors) may be disposed separately from but proximal to the housing 304 of EVCS 302. In some embodiments, the camera 310 may be positioned at different locations on EVCS 302 than what is shown. In some embodiments, the one or more cameras 310 include a plurality of cameras positioned at different locations on EVCS 302.

In some embodiments, EVCS 302 further comprises one or more sensors (not shown). In some embodiments, the one or more sensors detect external objects within a region (area) proximal to EVCS 302. In some embodiments, the area proximal to EVCS 302 includes one or more parking spaces where electric vehicles park in order to use EVCS 302. In some embodiments, the area proximal to EVCS 302 includes walking paths (e.g., sidewalks) next to EVCS 302. In some embodiments, the one or more sensors are configured to determine a state of the area proximal to EVCS 302 (e.g., wherein determining the state includes detecting external objects or the lack thereof). In some embodiments, the external objects can be living or nonliving, such as people, animals, vehicles, shopping carts, toys, etc. In some embodiments, the one or more sensors can detect stationary or moving external objects. In some embodiments, the one or more sensors may be one or more image (e.g., optical) sensors (e.g., one or more cameras 310), ultrasound sensors, depth sensors, infrared (IR) cameras, Red Green Blue (RGB) cameras, passive IR (PIR) cameras, thermal IR, proximity sensors, radar, tension sensors, near field communication (NFC) sensors, and/or any combination thereof. The one or more sensors may be connected to EVCS 302 or a computer system associated with EVCS 302 via wired or wireless connections such as via a Wi-Fi connection or Bluetooth connection.

In some embodiments, EVCS 302 further comprises one or more lights configured to provide predetermined illumination patterns indicating a status of EVCS 302. In some embodiments, at least one of the one or more lights is configured to illuminate an area proximal to EVCS 302 as a person approaches the area (e.g., a driver returning to a vehicle or a passenger exiting a vehicle that is parked in a parking spot associated with EVCS 302).

FIG. 3B illustrates an EVCS 352 used for charging the battery as well as climatically balancing the electric vehicle to a user-desired climatic setting based on the inferred dwell time of the user of the electric vehicle, in accordance with some embodiments of the disclosure. In some embodiments, FIG. 3B illustrates the EVCSs displayed in FIGS. 1 and 3A. In some embodiments, FIG. 3B displays additional views of EVCS 302 shown in FIG. 3A. In some embodiments, EVCS 352 comprises housing 354, one or more displays 356, charging cable 358, charging cable holder 360, and one or more cameras 362.

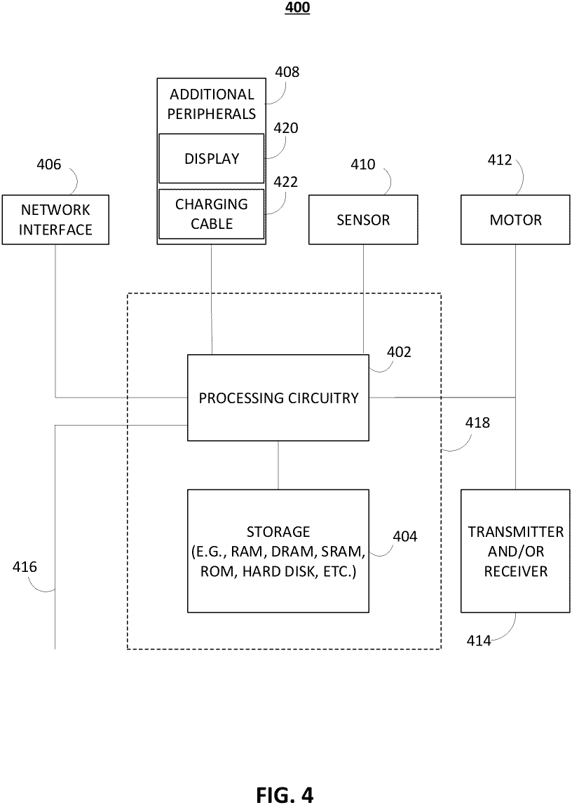

FIG. 4 shows an illustrative block diagram of an EVCS system 400, in accordance with some embodiments of the disclosure. In particular, EVCS system 400 of FIG. 4 may be any of the EVCSs depicted in FIGS. 1, 3A, and/or 3B. In practice, and as recognized by those of ordinary skill in the art, items shown separately could be combined, and some items could be separated. In some embodiments, not all shown items must be included in EVCS 400. In some embodiments, EVCS 400 may comprise additional items.

The EVCS system 400 can include processing circuitry 402 that includes one or more processing units (processors or cores), storage 404, one or more network or other communications network interfaces 406, additional peripherals 408, one or more sensors 410, a motor 412 (configured to retract a portion of a charging cable), one or more wireless transmitters and/or receivers 414, and one or more input/output (I/O) paths 416. I/O paths 416 may use communication buses for interconnecting the described components. I/O paths 416 can include circuitry (sometimes called a chipset) that interconnects and controls communications between system components. EVCS 400 may receive content and data via I/O paths 416. The I/O path 416 may provide data to control circuitry 418, which includes processing circuitry 402 and a storage 404. The control circuitry 418 may be used to send and receive commands, requests, and other suitable data using the I/O path 416. The I/O path 416 may connect the control circuitry 418 (and specifically the processing circuitry 402) to one or more communications paths. I/O functions may be provided by one or more of these communications paths but are shown as a single path in FIG. 4 to avoid overcomplicating the drawing.

The control circuitry 418 may be based on any suitable processing circuitry such as the processing circuitry 402. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The charging of an electric vehicle and climatically balancing it based on the inferred dwell time functionality can be at least partially implemented using the control circuitry 418. The charging of an electric vehicle based on the inferred dwell time functionality described herein may be implemented in or supported by any suitable software, hardware, or combination thereof. The charging of an electric vehicle based on the inferred dwell functionality can be implemented on user equipment, on remote servers, or across both.

The control circuitry 418 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 404 that is part of the control circuitry 418. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 404 includes one or more storage devices remotely located, such as database of server system that is in communication with EVCS 400. In some embodiments, the storage 404, or alternatively the non-volatile memory devices within the storage 404, includes a non-transitory computer-readable storage medium.

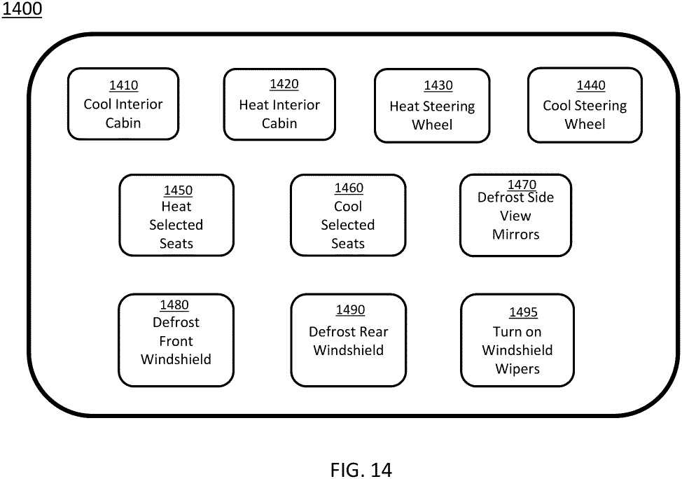

In some embodiments, storage 404 or the computer-readable storage medium of the storage 404 stores an operating system, which includes procedures for handling various basic system services and for performing hardware dependent tasks. In some embodiments, storage 404 or the computer-readable storage medium of the storage 404 stores a communications module, which is used for connecting EVCS 400 to other computers and devices via the one or more communication network interfaces 406 (wired or wireless), such as the internet, other wide area networks, local area networks, metropolitan area networks, and so on. In some embodiments, storage 404 or the computer-readable storage medium of the storage 404 stores a media item module for selecting and/or displaying media items on the display(s) 420 to be viewed by passersby and users of EVCS 400. In some embodiments, storage 404 or the computer-readable storage medium of the storage 404 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, storage 404 or computer-readable storage medium of the storage 404 stores a dwell time module (e.g., dwell time module 204). In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 404 stores a subset of the modules and data structures identified above. In some embodiments, the storage 404 may store additional modules or data structures not described above. In some embodiments, storage 404 or computer-readable storage medium of the storage 404 stores temperature and climate control settings preferred by a user, such as which temperatures and climate control settings for areas depicted in FIG. 14 are preferred by a user of the electric vehicle.

In some embodiments, EVCS 400 comprises additional peripherals 408 such as displays 420 for displaying content, and charging cable 422. In some embodiments, the displays 420 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 400 comprises one or more sensors 410 such as cameras (e.g., camera, described above with respect to FIGS. 1, 3A and/or 3B), ultrasound sensors, depth sensors, IR cameras, RGB cameras, PIR camera, thermal IR, proximity sensors, radar, tension sensors, NFC sensors, and/or any combination thereof. In some embodiments, the one or more sensors 410 are for detecting whether external objects are within a region proximal to EVCS 400, such as living and nonliving objects, and/or the status of EVCS 400 (e.g., available, occupied, etc.) in order to perform an operation, such as determining a vehicle characteristic, user information, region status, etc.

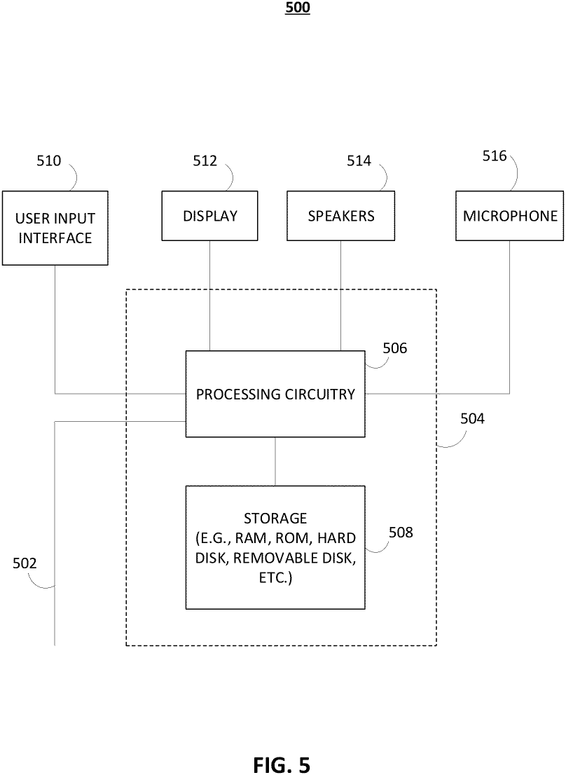

FIG. 5 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 500. In some embodiments, device 500 may comprise additional items. In an embodiment, the user equipment device 500, is the same user equipment device displayed in FIGS. 1, 2C, and/or 2D. The user equipment device 500 may receive content and data via I/O path 502. The I/O path 502 may provide audio content (e.g., broadcast programming, on-demand programming, Internet content, content available over a LAN or WAN, and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 504 may include communications circuitry suitable for communicating with one or more servers that may at least implement the described allocation of services functionality. The instructions for carrying out the above-mentioned functionality, such as climatically balancing the inside of the electric vehicle, may be stored on the one or more servers. Communications circuitry may include a cable modem, an ISDN modem, a DSL modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. Storage 508 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions). Cloud-based storage may be used to supplement the storage 508 or instead of the storage 508.

The control circuitry 504 may include audio generating circuitry and tuning circuitry, such as one or more analog tuners, audio generation circuitry, filters or any other suitable tuning or audio circuits or combinations of such circuits. The control circuitry 504 may also include scaler circuitry for upconverting and down converting content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 500 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504 which are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home, and similar such voice assistants) receive and process the voice commands and other speech.

The user equipment device 500 may optionally include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 510 may be HDTV-capable. In some embodiments, the display 512 may be a 3D display. The speaker (or speakers) 514 may be provided as integrated with other elements of user equipment device 500 or may be a stand-alone unit. In some embodiments, the display 512 may be outputted through speaker 514.

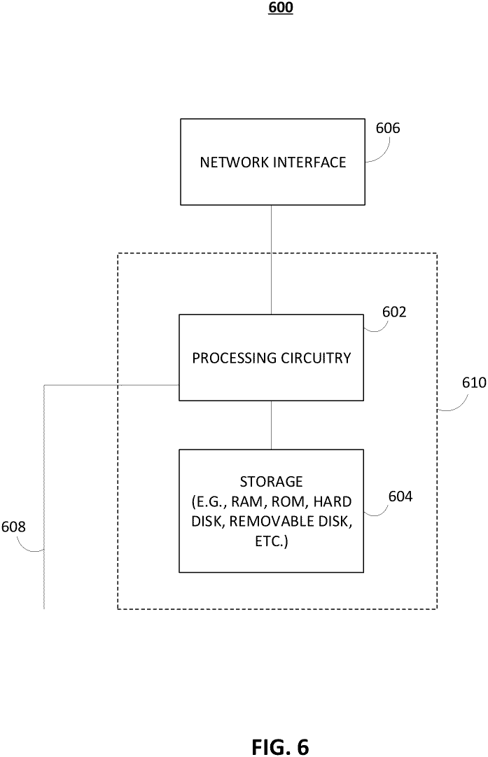

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602 that includes one or more processing units (processors or cores), storage 604, one or more network or other communications network interfaces 606, and one or more input/output (I/O) paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

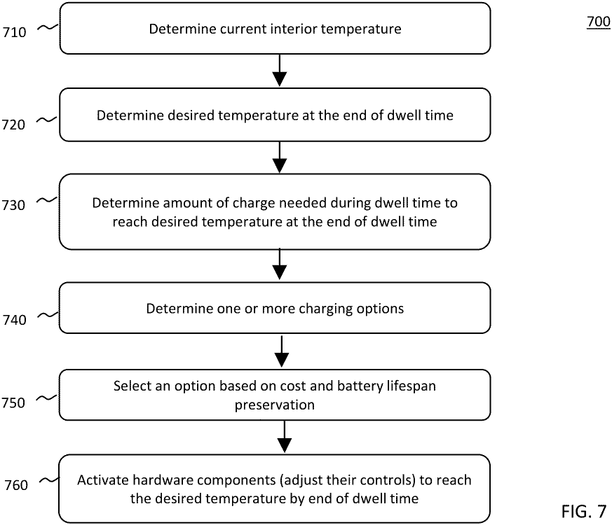

FIG. 7 is an illustrative flowchart of a process 700 for climatically balancing an electric vehicle to a desired temperature based on the inferred dwell time of the user of the electric vehicle, in accordance with some embodiments of the disclosure. Climatically balancing, also referred to as climate control or temperature control, may be performed by processes 700 and/or 800. Process 700 may be performed by physical or virtual control circuitry, such as control circuitry 418 of an EVCS (FIG. 4). In some embodiments, some steps of process 700 may be performed by one of several devices.

At step 710, control circuitry determines the interior temperature of the electric vehicle (e.g., electric vehicle 104 of FIG. 1). The electric vehicle may include one or more thermistors or sensors to measure the temperature inside the cabin area where seats are located. When a thermistor is used, it measures the temperature of a localized environment, such as the entire cabin of the electric vehicle or just the front or the back side of the cabin of the electric vehicle. The thermistor detects changes in electrical current when heat is added or removed to determine localized temperature.

Temperature sensors may also be used to determine the temperature of the interior cabin of the electric vehicle. For example, a temperature sensor that measures the voltage rise and drop across its terminals to determine the cabin temperature inside the electric vehicle may be used. Thermocouples and other type of temperature measuring devices may also be used.

In one embodiment, the temperature measuring devices may be located in a specific part of the cabin of the electric vehicle, and in another embodiment, they may be dispersed in a plurality of locations. For example, sensors may be located in or near the dashboard, in the driver and passenger seat, and in the rear seats of the cabin of the electric vehicle. Temperature measuring devices may also be located such that they can measure the temperature and detect frost or snow on the front and back windshield and sideview mirrors.

In some embodiments, the control circuitry receives a piece of user information in conjunction with receiving a request to climatically control the electric vehicle to a desired climate setting, such as to a desired temperature. In some embodiments, the control circuitry requests the user information from a database and/or server. In some embodiments, the control circuitry requests user information by submitting a request to a database and/or server wherein the request identifies the electric vehicle and/or one or more users of the electric vehicle. In some embodiments, the control circuitry receives the user information from a database, user, and or third-party provider.

At step 720, control circuitry determines the desired climatic environment, such as the desired temperature inside the cabin of the electric vehicle, that is to be achieved by a desired time. The desired temperature may be a predefined temperature provided by the user, a predetermined temperature provided by the manufacturer of the electric vehicle, or a temperature recommended by the charging station. For example, the temperature provided may be 72° F., which the user prefers in the interior cabin of the electric vehicle. The desired temperature may be obtained from the user’s profile, user information, the user’s temperature settings during previous rides, or directly from the user. The user may also have different desired temperatures based on the weather and outside conditions. For example, the user may have a desired temperature when it is raining, another desired temperature when it is a certain temperature outside, or a desired temperature when it is below a certain degree temperature in winter and above a certain degree temperature in summer that the user defines as too cold or hot for the user. In one embodiment, the user may change the desired temperature prior to their return to the electric vehicle.

The desired time, also referred to as the end of dwell time, or target time, is a time at which the electric vehicle should be charged and climatically controlled to a desired temperature, that is, the time at which the user will return to the vehicle. The time when the user will return to the electric vehicle is an estimated dwell time for the user based on user information. For example, information corresponding to the user being within a first vicinity is used to determine the time or a window of time within which the user is expected to return to the electric vehicle. In some embodiments, the first vicinity is within a threshold distance of an EVCS that is charging the electric vehicle such that both the battery is recharged and at the same time the charge is used for controlling the climatic environment. In some embodiments, the control circuitry can use one piece of user information or a plurality of user information to determine the estimated dwell time. In some embodiments, the control circuitry uses machine learning to determine the estimated dwell time using the received user information. In some embodiments, different user information is weighted according to significance. For example, a first piece of user information indicating that the user has an upcoming event may be weighted higher than a second piece of user information indicating that the user made a purchase two weeks ago. Accordingly, the control circuitry can use the different weights in determining an estimated dwell time for the user. In some embodiments, control circuitry uses electric vehicle characteristics, location information, and/or similar such information in conjunction with the received user information to determine the estimated dwell time. In some embodiments, the control circuitry notifies the user of the estimated dwell time. In some embodiments, the control circuitry offers the user an option to change the estimated dwell time. Regardless of the pieces of information used or how the dwell time is calculated, once a dwell time is determined, the control circuitry uses the dwell time to estimate the time at which the user will return to the electric vehicle, i.e., at the end (or within a threshold of the end) of the dwell time.

At step 730, control circuitry determines an estimated charge time using the estimated dwell time to charge the electric vehicle’s battery as well as climatically control the interior cabin of the electric vehicle to the desired temperature. This includes determining the charge needed to operate the associated hardware that will be used to achieve the desired temperature, for example, amount of charge needed to operate the air conditioning or seat warmers. In some embodiments, the charge may also be used to operate hardware, such as defrosters and other heating hardware for defrosting the windshield or the side-view mirrors.

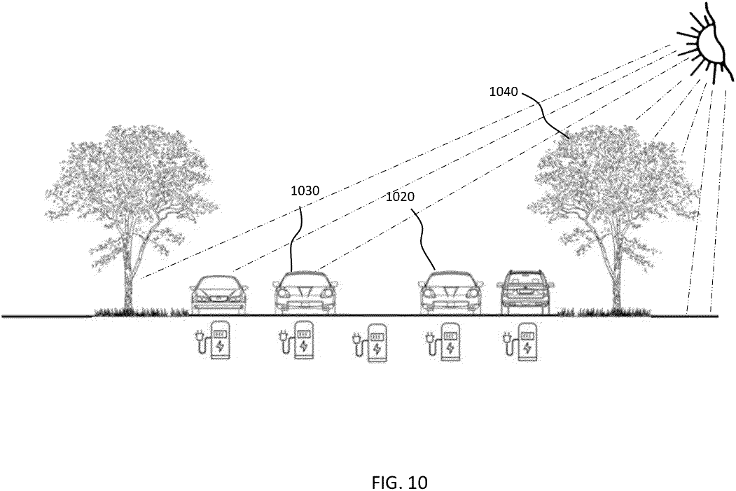

In some embodiments, the estimated charge time to charge the battery as well as climatically reach a desired climatic environment inside the electric vehicle may be the same or close to the estimated dwell time. In some embodiments, control circuitry may add or subtract time from the estimated dwell time based on additional factors to determine the estimated charge time and climate control time. For example, control circuitry may determine that the estimated charge and climate control time should be longer than the estimated dwell time to account for a user walking to and from an event. In some embodiments, control circuitry uses user information, electric vehicle characteristics, location information, and/or similar such information in conjunction with estimated dwell time to determine the estimated charge time and climate control time. For example, as shown in FIG. 10, control circuitry may use parking location information where a tree provides a shade to determine the amount of heat that will be generated within the inside cabin of the electric vehicle and the amount of air conditioning needed to cool the electric vehicle to a desired temperature. In some embodiments, the control circuitry uses machine learning to determine the estimated charge and climate control time. In some embodiments, different information is weighted according to significance when determining the estimated charge and climate control time. For example, the estimated dwell time may be weighted higher than user information indicating that the user made a purchase two weeks ago. Accordingly, the control circuitry can use the different weights in determining an estimated charge and climate control time for the electric vehicle. In some embodiments, the control circuitry notifies the user of the estimated charging and climate control time. In some embodiments, the control circuitry offers the user an option to change the estimated charging and climate control time.

In one embodiment, the desired temperature may be specific to a user of the electric vehicle. In another embodiment, the electric vehicle may store separate settings for different users of the electric vehicle, for example different family members, such as John and Sally, using the same electric vehicle may have different desired temperature and climatic preferences. John may prefer the electric vehicle to be cooler at 65° F. during summer while Sally may prefer the electric vehicle to be warmer at 75° F. during summer.

At step 740, based on the desired climatic temperature, the control circuitry determines one or more charging options to reach the desired temperature. These charging options include using one or more hardware components of the electric vehicle to reach the desired climatic environment. For example, the control circuitry may activate the air conditioning within the cabin of the electric vehicle and configure the settings and the fan speed such that the desired climatic environment may be reached by the end of dwell time. The control circuitry may also activate other heating or cooling elements within the electric vehicle to reach the desired temperature. In a colder environment, in some embodiments, the control circuitry may activate seat warmers, steering wheel warmers, defrosters, and/or defoggers for the sideview mirrors or the front and back windshield.

At step 750, the control circuitry may select a charging and climatic control option that is based on cost of charging and battery lifespan preservation. For example, slower charging may be performed based on a lower charging rate for longer estimated charge times (e.g., two hours), and a faster charging rate may be used for shorter estimated charge times (e.g., 15 minutes). The charging speed, rate, and duration may be selected to optimize maximum charging while reaching the desired climatic environment for the electric vehicle while minimizing unnecessarily fast charging, resulting in a prolonged lifespan of the vehicle’s battery and cost savings.

At step 760, the control circuitry may configure the settings for the hardware components selected and activate them to reach the climatic temperature. The control circuitry may turn on the air conditioning vents at low, medium, or high speed, or any other setting that is offered by the electric vehicle. The control circuitry may also change the setting over a period of time, such as, the control circuitry may configure a high fan speed or temperature setting for the air conditioner and then lower the setting once the desired temperature is reached, in order to maintain it. The control circuitry may also activate the defroster or defogger when it detects that the electric vehicle has an ice or snow layer on top of it, and then it may turn off the defroster or defogger once the snow or ice layer is melted from the front and/or back windshield.

In some embodiments, once the desired climatic environment is reached, the control circuitry may adjust the settings of the heating and cooling elements to maintain the reached climatic environment until the user returns to the electric vehicle. In another embodiment, once the desired climatic environment is reached, the control circuitry may send a message to the user informing them that the desired climatic environment is reached. In yet another embodiment, the control circuitry may provide selectable options on a graphical user interface displayed on the user’s mobile phone and provide options to continue maintaining the climatically controlled environment inside the electric vehicle, increase or decrease a temperature setting, or turn off the climate control hardware. The options provided to the user are not so limited, and other options to control the settings of hardware used for climatically balancing the electric vehicle may also be provided to the user.

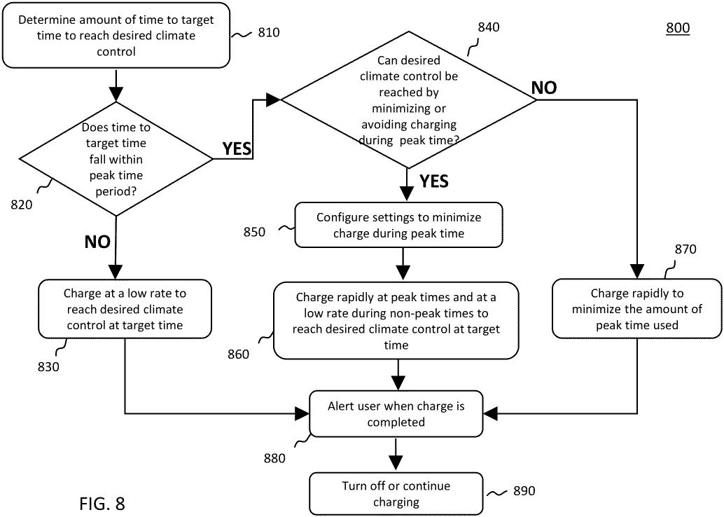

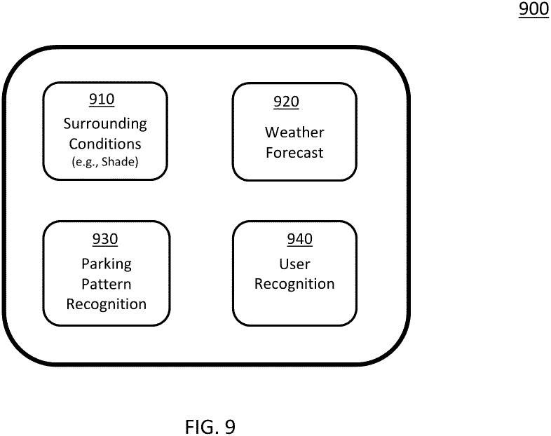

FIG. 8 is another illustrative flowchart of a process 800 for charging an electric vehicle and reaching a desired climatic environment based on the inferred dwell time of the user of the electric vehicle, in accordance with some embodiments of the disclosure. Process 800 may be performed by physical or virtual control circuitry, such as control circuitry 418 of an EVCS (FIG. 4). In some embodiments, some steps of process 800 may be performed by one of several devices.

At step 810, the control circuitry determines the amount of time to the target time at which the electric vehicle is to reach the desired climate control. The target time is the time at which the user desires the electric vehicle to reach the desired temperature and likely the time at which the user plans to return to the electric vehicle and use it. In one embodiment, the user may set the target time and in another embodiment the system may determine target time based on the dwell time. The time to the target time may vary, such as it may be 30 minutes, or it may be three hours.

At step 820, the control circuitry determines whether the time to the target time falls within a peak time period. In some embodiments, the peak time period may be between certain hours and in other embodiments peak time period may be during the busiest charging time or during the time when the power grid’s use is above a threshold.

At block 820, if a determination is made that the time to the target time does not fall within the peak time, then the process moves to step 830, where the control circuitry charges the electric vehicle at a low rate to reach the desired climate control by the target time. Charging at a low rate results in a prolonged lifespan of the vehicle’s battery and does not put additional strain and pressure on the battery, as rapid charging does. Since the pricing and costs at non-peak hours are lower than peak hours, the battery can be charged at a low rate to reach the desired temperature within the desired target time.

In one embodiment, when charging with a low rate, the control circuitry may determine the amount of time needed to charge at the low rate and adjust the charge settings accordingly. For example, if the amount of time to charge to the desired climate balance at a low setting would require 40 minutes and the amount of time to the target time is 30 minutes, then the control circuitry would charge at a low rate for a certain time and then ramp up the charging speed such that the desired climate balance can be reached within the 30 minutes of target time. The control circuitry may also explore a plurality of charging options, such as varying charge speed, charging entirely at low charging rate or ramping up at a certain time, etc., and then select a charging option that is best from a cost and battery lifespan perspective.

At block 880, once the charge at the low rate is completed, the control circuitry may send a message to the user informing them that the desired climatic environment is reached and may provide options to the user for next steps.

At block 820, if a determination is made that the time to the target time falls within the peak time, then the process moves to step 840, where the control circuitry makes a further determination whether the desired temperature can be reached by minimizing charging time during the peak time. The control circuitry evaluates various charging options that involve charging rates, battery lifespan considerations, and the time available to charge the electric vehicle by target time such that both the electric vehicle’s battery is charged, and the desired climate control is reached. Th control circuitry then selects a charging option that is best from a cost and battery lifespan perspective while minimizing amount of charge time during peak hours.

If a determination is made at step 840 that charging and climate control can be reached by minimizing charge during peak time, then, at step 850, the control circuitry configures the settings to minimize charge during peak time. This includes controlling the settings of the heating and cooling hardware in the electric vehicle and controlling the charging speed and times to achieve the desired charge and climate control by the target time.

For example, a target time to reach the climate control and charge the electric vehicle may be 45 minutes, which is the end of dwell time when the user will return to the electric vehicle. If the peak hours end in 15 minutes, then the control circuitry determines whether the desired charge to the battery and the climate control can be reached if the charging is not performed in the first 15 minutes, which fall during the peak hours, and is performed in the last 30 minutes to the target time, which is after the peak hours. If a determination is made that desired charge and climate control can be reached in the last 30 minutes, which is after peak hours, then the control circuitry selects the option to skip or avoid charging during peak hours and start the charging process after the peak hours have ended.

In some embodiments, the control circuitry makes a determination if charging during peak time can be avoided altogether, and if so, not charging during peak time is preferred. For example, a 10 kWh charge is needed to charge the electric vehicle’s battery as well as climatically control the electric vehicle to the desired temperature. In this example, the current time falls within peak time; however, peak time is about to end in 30 minutes. If the end of dwell time is 50 minutes, i.e., dwell time ends 20 minutes after peak time, and the 10 kWh can be charged after peak time ends and during the 20 minutes of non-peak time by rapidly (or at another pace) charging during the non-peak time, then the control circuitry selects charging in non-peak times with a rapid charge (or other pace of charging) over charging during the peak time.

At step 860, the control circuitry may determine an option to charge rapidly during peak time and at lower rate during non-peak time to reach the desired climate control. For example, a target time to reach the climate control and charge the electric vehicle is 35 minutes, which is the end of dwell time when the user will return to the electric vehicle. If the peak hours end in 15 minutes, then the control circuitry determines whether the desired charge to the battery and the climate control can be reached if the charging is not performed in the first 15 minutes, which fall during the peak hours, and is performed in the last 20 minutes to the target time, which is after the peak hours. If a determination is made that desired charge and climate control cannot be reached in the last 20 minutes and a total of 30 minutes of charge time is required, then the control circuitry may skip the first five minutes during peak hours and start the charging process after the expiration of the first five minutes. Using this option, the control circuitry would minimize the amount of charging performed during peak hours to 10 minutes and use the remaining 20 minutes needed during non-peak time to charge the battery and reaching the climate control. If the 10 minutes of peak time can be further reduced by rapidly charging during peak time, then the control circuitry may select such an option.

If a determination is made at step 840, that charging the battery and climate control cannot be reached by minimizing charge during peak time, then at step 870, the control circuitry configures a setting to rapidly charge the battery and reach the target climate control by the target time.

For example, a target time to reach the climate control and charge the electric vehicle may be 30 minutes. If the entire 30 minutes fall within the peak charging hours, then, instead of charging the battery and performing climate control at a low rate the control circuitry may rapidly charge the battery and perform climate control. That is, the control circuitry may select an option to minimize the amount of time used during peak charge times and perform rapid charging to achieve the desired charge and climate control.

At block 880, regardless of the options selected to charge the battery of the electric vehicle and perform climate control, i.e., either through step 830, steps 840-860, or steps 840 and 870, once the battery and climate control have reached a desired level, the control circuitry may send an alert/message to the user informing them that the desired climatic environment is reached and provide options to the user for next steps.

At step 890, the control circuitry may provide selectable options on a graphical user interface displayed on the user’s mobile phone and provide options to continue maintaining the climatically controlled environment inside the electric vehicle, increase or decrease a temperature setting, or turn off the climate control hardware. The options provided to the user are not so limited and other options, such as turn on/off seat warmers, defrosters, or defoggers, to control the settings of hardware used for climatically balancing the electric vehicle may also be provided to the user. In some embodiments, if the electric vehicle is retrofitted with electric aroma diffusers, the control circuitry may activate them as well.

FIG. 9 is a block diagram of some of the factors considered in climatically balancing the electric vehicle, in accordance with some embodiments of the disclosure. In one embodiment, at block 910, the control circuitry may evaluate surrounding conditions where the electric vehicle is parked to determine climate control options. For example, one of the surrounding conditions that may be evaluated by the control circuitry includes the amount of direct exposure of the electric vehicle to sunlight. As depicted in exemplary FIG. 10, the control circuitry may determine the effect of parking location on balancing the electric vehicle climatically, in accordance with some embodiments of the disclosure.

As depicted in FIG. 10, an electric vehicle parked at spot 1020 has a different amount of direct exposure to sunlight than the electric vehicle parked at spot 1030. As such, the temperature inside the cabin of the electric vehicle 1020 will be different from the temperature inside the cabin of the electric vehicle 1030. Since electric vehicle 1030 has more sunlight exposure, the temperature inside electric vehicle 1030 will be higher than electric vehicle 1020, which is parked in a location that receives a shade from tree 1040.

In one embodiment, the user of the electric vehicle may prefer the temperature inside the electric vehicle cabin to be at a certain temperature, e.g., 70° F. (70° F.), when the user returns to the electric vehicle. The electric vehicle 1030, which is not parked under the shade, may reach an inside cabin temperature of 100° F., while the electric vehicle 1020 parked in a location that receives the tree shade may reach an inside cabin temperature of 80° degrees Fahrenheit.

The control circuitry may use sensors and cameras around the electric vehicle to determine the current amount of shade and the angle of sunlight and calculate the amount and duration of shade that the electric vehicle may continue to receive until the end of the dwell time. The control circuitry may then determine the potential temperature that the inside cabin of the electric vehicle may reach based on the shade and sunlight and calculate the amount of charge needed to reach the desired climatic condition and temperature by the time the user returns to the electric vehicle. An electric vehicle with the higher inside temperature of 100° F., such as electric vehicle 1030, may need more charging time to reach a desired temperature of 70° F. than the electric vehicle 1020, which is at 80° F. Therefore, the control circuitry may configure different settings for cooling hardware elements of the electric vehicle and different charge durations for the electric vehicle parked in spot 1030 than the electric vehicle parked at spot 1020. The control circuitry may also store the sunlight and shade data for a specific location using the global positioning system (GPS) of the electric vehicle such that if a user routinely parks in the same spot, the control circuitry may use previous data to configure cooling and charging options for the electric vehicle.

In another embodiment, the electric vehicle may be black in color. Since black, or another darker color, absorbs more light energy than lighter colors, the control circuitry may factor in the electric vehicle’s color in determining the amount of heat absorbed if a black electric vehicle is parked with direct exposure to sunlight. The control circuitry may also calculate the amount of the rise in temperature inside the cabin of the electric vehicle based on the absorption rate relating to the electric vehicle’s color. The calculations may be used to predict the temperature inside the electric vehicle until the end of the dwell time and the amount of cooling required to reach a desired temperature. The heat absorption calculation and the amount of cooling required will be used as a factor in determining the amount of charge needed to be able to reach the desired temperature for a black electric vehicle with a certain calculated absorption factor. In another embodiment, where the color of the electric vehicle is white or a lighter color, the control circuitry may calculate the heat absorption for such colors and determine the amount of charge needed to reach the desired temperature. Since black and darker colors absorb more heat, the amount of energy needed to cool a black electric vehicle will be more than the amount of energy needed to cool a lighter color electric vehicle. As such, the amount of charge needed to cool a black electric vehicle will also be more than needed for a lighter color electric, vehicle and the control circuitry would factor in the color to determine the amount of charge needed.

Referring back to FIG. 9, in another embodiment, at block 920, the control circuitry may obtain the weather forecast from a plurality of sources to determine the effects of weather on the electric vehicle and inside the cabin of the electric vehicle. For example, the control circuitry may obtain weather data for the area where the electric vehicle is parked from the Internet, including from one of several weather reporting sources. The weather forecast data may be used by the control circuitry to evaluate the amount of charge needed to climatically balance the electric vehicle to a desired setting.

In one embodiment, the weather forecast may call for snow conditions. As such, the control circuitry may determine that heating and defrosting elements to defrost the front and rear windshields and the sideview mirrors of the electric vehicle will need to be used to remove the snow and defrost the windshields and the mirrors by the target time. Since activating those heating and defrosting elements requires additional charge, the control circuitry would factor in the amount of additional charge needed and select its charging options accordingly.

In another embodiment, the current outside temperature may be 90° F., but the weather forecast may predict that there will be a drop in temperature to 70° F. within the dwell time. If the desired temperature to be reached at the end of the dwell time is 70° F., then the control circuitry may determine that additional charge is not needed to climatically control the electric vehicle to 70° F., since, based on the weather forecast, the inside of the cabin will automatically reach 70° F. without the need to perform any temperature control functions. The control circuitry may also monitor the changing forecast to adjust its charge and climate control settings such that minimal charge is used to reach desired climatic environment, especially when a charge is not needed, due to weather conditions, to reach the desired climatic environment.

In another embodiment, at block 930, the control circuitry may detect parking patterns, such as parking locations, based on parking history of the user. For example, if the user usually charges their electric vehicle at work in a covered parking garage that is cooler than an uncovered spot outside the garage, the control circuitry may determine that a lesser amount of charge is needed to climatically balance the electric vehicle to the desired temperature than if the electric vehicle were parked outside the garage.

For example, in one embodiment, the electric vehicle may have been driven in heat, and the inside cabin temperature is 80° F. when it enters the garage. Thus, when the electric vehicle is first parked, its inside temperature is also 80° F. If the desired temperature at end of dwell time is 70° F., the control circuitry, using GPS of the electric vehicle, may recognize that the electric vehicle is parked in its usual spot, i.e., the covered garage, which provides a cooler surrounding temperature. As such, the control circuitry, based on prior data, recognizes that when the electric vehicle is parked inside the garage, it automatically cools down to 70° F. without the need for turning on cooling elements to reach a cooler inside cabin temperature. As such, control circuitry may determine that an additional charge is not needed to cool the current temperature of inside cabin of the electric vehicle from 80° F. to a desired temperature of 70° F. based on parking pattern recognition. It may recognize that, based on the parking spot, the electric vehicle will automatically reach 70° F. without any climate control functions activated.

In another embodiment, at block 940, the control circuitry may detect which user is currently using the electric vehicle in determining the desired climate control at the end of dwell time and the charge needed to reach such desired climate control.

Since an electric vehicle may be used by multiple members of a family, or multiple friends, colleagues, or roommates, the control circuitry may store a user profile for each user that is authorized to use the electric vehicle. In one embodiment, each user profile may include a desired temperature and climate control setting for the electric vehicle. In another embodiment, the control circuitry may detect patterns for each separate user based on how the user configures the heating and cooling settings while they are driving the electric vehicle. The control circuitry may store data from the detected patterns in the user profile such that when it detects the same user using the electric vehicle it can retrieve the pattern data from the profile and use it to determine the desired climate control and the amount and type of charge needed to reach the desired climate control.

In some embodiments, the control circuitry may also provide an option for the user to save or modify a recommended climate control setting. For example, the control circuitry may use one or more of the other factors, such as factors presented in blocks 910, 920, and 930, to make a recommendation to the user of a climate control setting, such as the temperature inside the cabin of the electric vehicle, at the end of the dwell time. The recommendation may be made to an existing user or to a new user. Based on their response to the recommendation, or modification to the recommendation, the control circuitry may save the data in the user profile for later use.

In another embodiment, a recommendation that is outside the user profile may be made. For example, if a user prefers the electric vehicle to be at 70° F., however, the control circuitry determines that the outside temperature, based on forecast, will be much cooler, then the control circuitry may recommend a higher temperature setting for inside of the cabin and configure charging and climate control options based on response to the recommendation made.

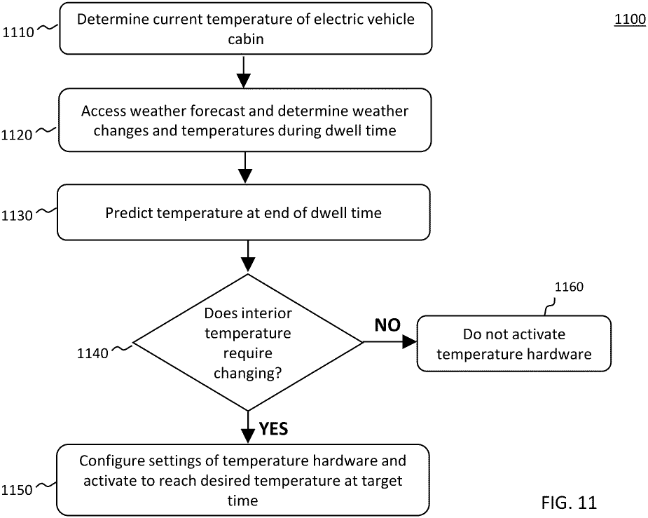

FIG. 11 is a flowchart of a process for climatically balancing the interior cabin of an electric vehicle by utilizing the weather forecast, in accordance with some embodiments of the disclosure.

At step 1110, the control circuitry determines the current temperature of the cabin inside the electric vehicle. The cabin includes the driver and passenger seating area inside the electric vehicle. In some embodiments, an average temperature of the interior cabin of the electric vehicle is determined. In another embodiment, there may be separate climatic zones within the interior cabin of the electric vehicle. These separate climatic zones may be, for example, a separate climatic zone for the driver, a separate climatic zone for the front seat passenger, and separate climatic zones for each passenger seat in the rear of the electric vehicle including separate climatic zones for each row of passenger seats in the rear of the electric vehicle. The climatic zones may also be one separate climatic zone for the front seating area of the electric vehicle and another separate climate zone for the rear seating area of the electric vehicle.

At step 1120, the control circuitry may access a weather forecast and determine predicted weather and temperature changes during dwell time. These weather changes may include fluctuations in outside temperature, precipitation, weather conditions relating to snow, storms, winds, and other weather changes.

At step 1130, the control circuitry may use the weather forecast and information relating to weather changes in predicting the temperature inside the cabin of the electric vehicle between the current time and the end of the dwell time. For example, if the weather forecast calls for an increased hotter outside temperature, then the control circuitry may use the forecast to determine the effects of the outside temperature on the inside cabin of the electric vehicle. It may determine that, since the weather is getting warmer, it will require additional energy to cool the cabin, and therefore additional charging time will be needed to reach the desired temperature and maintain it during the hotter weather.

Likewise, if the forecast calls for a sudden drop in temperature, a storm, a snow forecast, or some other weather event, then the control circuitry may use the weather forecast data to determine temperature changes inside the cabin from the current time until the end of the dwell time.

At block 1140, the control circuitry may determine, based on the forecast, if the interior temperature in the cabin of the electric vehicle requires changing. As explain earlier, if the desired interior cabin temperature for the user driving the electric vehicle is 70° F. and, based on the weather forecast, the control circuitry determines that the drop in outside temperature will result in the inside cabin temperature reaching 70° F. on its own, then, at block 1160, the control circuitry will not activate any temperature hardware. As such, the control circuitry would select an option that saves on the additional charging that would have been required if the weather forecast was not factored into the climatic control determination.

The control circuitry may also use a threshold, such as a 5-10% threshold, to determine if it needs to activate the heating or cooling hardware elements of the electric vehicle based on the weather conditions. For example, based on the weather forecast, if the control circuitry determines that the temperature inside the cabin would reach 67° F. on its own, which is within a 5% threshold of 70° F. desired temperature, then the control circuitry may not activate any heating or cooling hardware of the electric vehicle if a 5% threshold is acceptable to the user.

In another embodiment, if, at block 1140, the control circuitry determines, based on the forecast, that the cooling or heating hardware in the electric vehicle needs to be activated, then the control circuitry may do so to reach the desired climatic environment at end of dwell time. By taking a weather forecast into account and calculating a projected interior cabin temperature, the control circuitry is able to enhance its predictions on the amount of charge and the duration of charge needed to reach the desired climatic environment at end of dwell time.

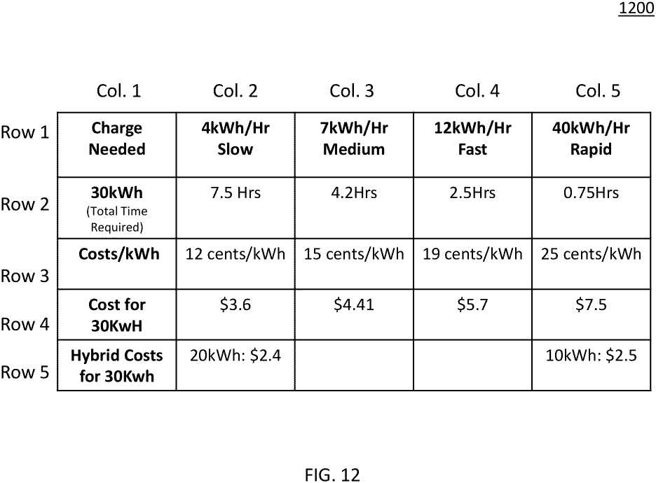

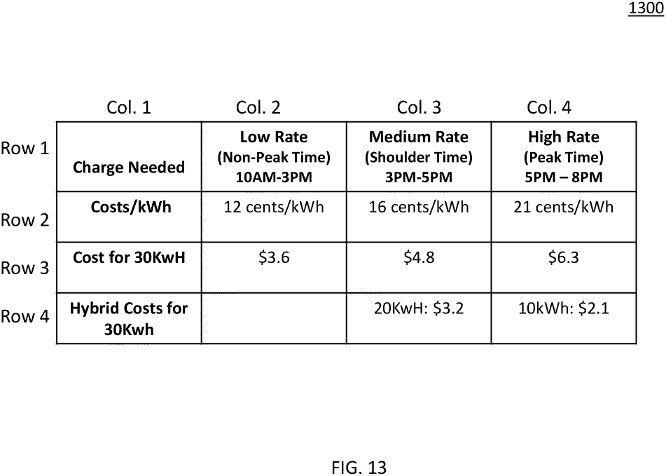

FIGS. 12 and 13 are exemplary tables of charging costs, speed of charging, and peak times that may be considered by the control circuitry to determine charging options to charge the electric vehicle as well as climatically control the inside cabin to a desired setting.

FIG. 12 is a table depicting exemplary charging costs and duration for charging the electric vehicle’s battery and climatically balancing the electric vehicle, in accordance with some embodiments of the disclosure. The table includes rows 1-5, where row 1 depicts the types of charging options in term of kilowatts per hour and their speeds, from slow to rapid. Row 2 depicts the amount of time it will take to charge an electric vehicle’s battery by 30 kWh based on the type of charging option selected. For example, it would take 7.5 hours (as depicted in row 2, column 2) to charge an electric vehicle’s battery with a charge of 30 kWh if a slow charging speed of 4 kWh/hr is selected. At this speed, the cost per kWh would be 12 cents and a total cost of $3.60 (as depicted in row 3 and 4 of column 2) would apply if all the charging is done on the slow speed for 7.5 hours.

In some embodiments, rows 2 and 4 of column 3 of table 1200 depicts the total time and costs if the 30 kWh charge was achieved using a medium charging speed. As depicted, it would take 4.2 hours (as depicted in row 2, column 3) to charge an electric vehicle’s battery with a charge of 30 kWh if a medium charging speed of 7 kWh/hr is selected. At this speed, the cost per kWh would be higher than the slow charging speed and it would cost 15 cents/kWh and a total cost of $4.41 would apply if all the charging is done on the medium speed for 4.2 hours.

In another embodiment, column 4 of table 1200 depicts the total time and costs if the 30 kWh charge was achieved using a fast charging speed. As depicted, it would take 2.5 hours to charge an electric vehicle’s battery with a charge of 30 kWh if a fast charging speed of 12 kWh/hr is selected. At this speed, the cost per kWh would be higher than the medium charging speed and it would cost 19 cents/kWh and a total cost of $5.7 would apply if all the charging is done on the fast speed for 2.5 hours.

In another embodiment, column 5 of table 1200 depicts the total time and costs if the 30 kWh charge was achieved using this highest speed, which may be rapid charging. As depicted, it would take 0.75 hours to charge an electric vehicle’s battery with a charge of 30 kWh if a fast charging speed of 40 kWh/hr is selected. At this speed, the cost per kWh would be higher than the fast charging speed and it would cost 25 cents/kWh and a total cost of $7.5 would apply if all the charging is done on the fast speed for 2.5 hours.

The charging speeds shown in Column 2-5 are exemplary and they may vary at each charging station. Other charging speeds and costs, as described earlier in the application, and other variations of charging speeds and costs may also be provided to the user.

In another embodiment, row 5 of table 1200 depicts one exemplary charging option where a hybrid model may be used by the control circuitry to charge the battery as well as reach the desired climatic environment inside the electric vehicle by the target time. The hybrid model may include charging the electric vehicle at a slow charging speed for 5 hours and then charging rapidly for 18.75 minutes to charge an electric vehicle’s battery with a charge of 30 kWh within a total time span of 5 hours and 18.75 minutes. The slow charging would cost a total of $2.40 to charge an electric vehicle’s battery with a charge of 20 kWh, and the rapid charging would cost a total of $2.5 for a charge up to 10 kWh. The hybrid model may be selected based on several factors such as amount of time to end of dwell time, peak hours, cost, and weather conditions. Other hybrid models that combine slow, medium, fast, and rapid charges are also contemplated and may be selected based on one or more of the factors.

FIG. 13 is a table depicting exemplary charging costs during peak and non-peak charging times and adjusting the charging schedule based on the dwell time to provide options to the user of the electric vehicle, in accordance with some embodiments of the disclosure. The charging options depicted in FIG. 13 can be used for charging the electric vehicle’s battery, climatically balancing the electric vehicle, and both charging the electric vehicle as well as climatically balancing the electric vehicle.

Table 1300 includes rows 1-4, where row 1 depicts the types of charging options in term of low, medium and high costs for kilowatts per hour of charging. The costs may vary by charging station and range from non-peak rate to peak rate. Row 2 depicts costs on a kilowatt per hour basis that range from 12 cents to 21 cents, depending on the time of charging. Although the non-peak to peak is described in this embodiment based on the time of charging, non-peak to peak charges may not be based on hours and may be based on other factors such as busy times; the overall use of the electric grid, e.g., low to high use of electric grid at certain times; wait times at certain locations based on amount of demand; and other factors used by charging stations to vary from low to high rates.

In one embodiment, row 3 of table 1300 depicts the total cost of charging if the 30 kWh charge was achieved using a low rate of 12 cents/kWh, medium rate of 16 cents/kWh, or a high rate of 21 cents/kWh. As depicted, it would cost $3.6 to reach the charge of 30 kWh if a low rate of 12 cents/kWh was selected, $4.8 to reach the charge of 30 kWh if a medium rate of 16 cents/kWh was selected, and $6.3 to reach the charge of 30 kWh if a high rate of 21 cents/kWh was selected by the control circuitry.

In another embodiment, row 4 of table 1300 depicts one exemplary charging option where a hybrid model may be used by the control circuitry to charge the battery as well as reach the desired climatic environment inside the electric vehicle by the target time. The hybrid model may include charging the electric vehicle at a medium rate to achieve a charge of 20 kWh that would cost $3.2 and then at a high rate to achieve a charge of 10 kWh for a cost of $2.1 and a total of 30 kWh through the hybrid method for a total cost of $5.3.

The control circuitry may obtain the times and factors for low, medium, and high rates and, depending on when the electric vehicle is placed on a charge, may select a charging option to minimize costs to the user. For example, if the electric vehicle is parked at a charging station and the control circuitry determines that a change in charging price is to occur during dwell time, where the price may go up or down, then control circuitry may factor in the costs, dwell time, amount of charge needed to select a hybrid model that achieves the charge needed at a lower cost.

FIG. 14 is a block diagram of some of heating and cooling zones that may be climatically balanced, in accordance with some embodiments of the disclosure.

At block 1410, the control circuitry may cool the cabin, which is the interior portion of the electric vehicle. As described earlier, the cabin may include one climatic zone for the entire inside of the electric vehicle or may include separate climatic zones, for example, a separate climatic zone for the driver, a separate climatic zone for the front seat passenger, and separate climatic zones for each passenger seat in the rear of the electric vehicle including separate climatic zones for each row of passenger seats in the rear of the electric vehicle. The climatic zones may also be one separate climatic zone for the front seating area of the electric vehicle and another separate climate zone for the rear seating area of the electric vehicle. To cool the entire inside cabin or separate climatic zones, the control circuitry may use air conditioning and fans and select their settings, such as low, medium, high, or any other scale provided by the electric vehicle, to climatically control the cabin, or a separate zone of the cabin, to a desired climatic environment.

At block 1420, the control circuitry may heat the cabin or a separate climatic zone within the cabin. To heat the cabin, or a zone of the cabin, the control circuitry may use hardware components such as a heater and a fan and select their settings, such as low, medium, high, or any other scale provided by the electric vehicle to climatically heat the cabin, or a separate zone of the cabin, to a desired heated environment.

At blocks 1430 and 1440, the control circuitry may cool or heat the steering wheel of the electric vehicle to a desired temperature. In some embodiments, the electric vehicle may offer options to heat or cool a steering wheel such that in cold and hot climates the user can easily grab the steering wheel without experiencing a very hot or cold steering wheel by their hands when they return to the electric vehicle.

At blocks 1450 and 1460, the control circuitry may cool or heat a seat or multiple seats of the electric vehicle to reach a desired temperature. In some embodiments, the electric vehicle may offer options to heat or cool a driver seat, passenger seat, or all seats in the electric vehicle such that in cold and hot climates the user can avoid a very hot or cold seat when they first sit in the electric vehicle after their return to the electric vehicle. As in many vehicles, there may be heating coils or cooling elements underneath the seat that allows hot or cold air to heat or warm the seat by allowing the air or heat and cold to exit from the perforations of the seat. Other mechanisms may also be used to heat and/or cool the seat, such as, for example, air blown through a diffusion layer under the seat fabric to spread upward to the surface and heat or cool the seats.

At block 1470, the control circuitry may defrost the sideview mirrors of the electric vehicle. In some embodiments, the control circuitry may make a determination whether the side-view mirrors need defrosting or defogging based on a temperature reading that may be performed by the control circuitry. The control circuitry may also use sensors to determine if a layer of ice or snow has covered the sideview mirrors such that they need to be defrosted.

At blocks 1480 and 1490, the control circuitry may defrost the front and back windshields of the electric vehicle. In some embodiments, the control circuitry may make a determination whether the front and back windshields need defrosting or defogging based on a temperature reading that may be performed by the control circuitry. The control circuitry may also use sensors to determine if a layer of ice or snow has covered the front and back windshields, such that they need to be defrosted.

At block 1495, the control circuitry may turn on the windshield wipers for the front and/or the back windshield if precipitation is detected. In some embodiments, the control circuitry may make a determination whether the windshields have precipitation deposited on them, such as rain or dew, and activate the windshield wipers to clear the precipitation.

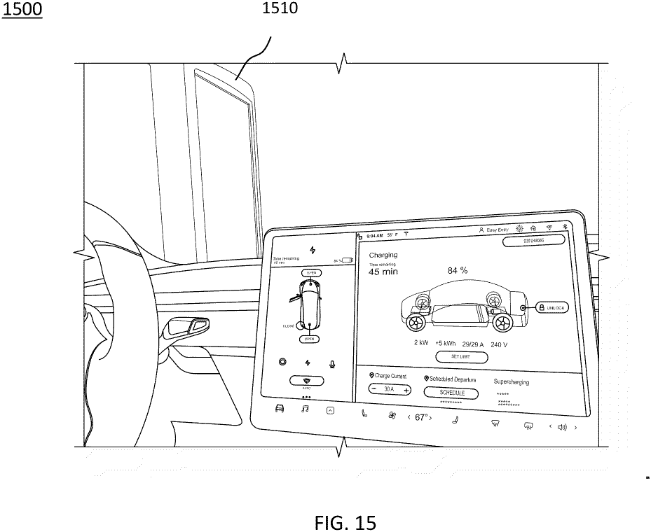

FIG. 15 illustrates an EVCS comprising a step-down transformer charging an electric vehicle, in accordance with some embodiments of the disclosure. As demonstrated by the system 1500, the EVCS is charging with 240 V and at a charging rate of 7 kWh. Stepping down the power at the EVCS results in a more efficient charging rate because the stepped-down power is transmitted directly to the electric vehicle after being stepped down instead of first being transmitted over cables from the power source, such as from the closet EVCS 1510 where the charging power source is located.

In some embodiments, the methodologies described herein result in the EVCS having excess power. For example, if an electric vehicle requires a first charging rate (e.g., 5 kW per hour), a first EVCS (without a step-down transformer) has to use all the stepped-down power received from the power source to charge the electric vehicle. However, a second EVCS (with a step-down transformer) may receive the power from the power source and step down the power to an appropriate level. The second EVCS may be able to charge the electric vehicle at a higher charging rate (e.g., 7 kW per hour) after stepping down the power because there is less power loss than with the first EVCS without the transformer. Instead of using the higher charging rate (e.g., 7 kW per hour), the second EVCS may charge the electric vehicle with the first charging rate (e.g., 5kW per hour) and save any excess power for other functions. In some embodiments, the other functions may include climatically controlling the electric vehicle to a desired temperature, including turning on heating and cooling components of the electric vehicle to cool or warm the interior cabin of the electric vehicle.

It is contemplated that some suitable steps or suitable descriptions of the above may be used with other suitable embodiments of this disclosure. In addition, some suitable steps and descriptions described in relation to the above may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in above could be used to perform one or more of the steps of the processes described above.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method of climatically balancing an electric vehicle comprising:
detecting a request to charge an electric vehicle that is electrically connected to an electric vehicle charging station (EVCS);
receiving information of a desired climatic setting that is to be reached by an end of a dwell time;
calculating an amount of electric charge needed to reach the desired climatic setting by the end of the dwell time;
selecting a charging option based on one or more factors to charge the electric vehicle based on the calculated amount of charge; and
activating one or more cooling or heating hardware elements of the electric vehicle to reach the desired climatic setting by the end of the dwell time.

2. The method of claim 1, wherein calculating an amount of electric charge needed to reach the desired climatic setting by the end of the dwell time further comprises:
determining, using a temperature-reading component, a current temperature of an inside cabin of the electric vehicle; and
calculating the amount of charge needed, based on the current temperature, to reach the desired climatic setting.

3. The method of claim 2, wherein the calculating the amount of charge needed includes the determining the amount of charge needed to activate heating and/or cooling hardware components of the electric vehicle to reach the desired climatic setting by the end of a dwell time.

4. The method of claim 2, wherein a factor, from the one or more factors, is a weather forecast, and the method further comprises:
obtaining the weather forecast for the area where the electric vehicle is parked for charging;
predicting temperature changes within the inside cabin of the electric vehicle based on the weather forecast; and
determining, based on the predicted temperatures, whether the one or more cooling or heating hardware elements of the electric vehicle need to be activated to reach the desired climatic setting by the end of a dwell time.

5. The method of claim 3, further comprising not activating the one or more cooling or heating hardware elements of the electric vehicle.

6. The method of claim 1, wherein activating one or more cooling or heating hardware elements of the electric vehicle includes activating an air conditioning system of the electric vehicle and selecting a fan setting to cool an inside cabin of the electric vehicle.

7. The method of claim 1, wherein activating one or more cooling or heating hardware elements of the electric vehicle includes activating a heating system of the electric vehicle and selecting a fan setting to heat an inside cabin of the electric vehicle.

8. The method of claim 1, wherein activating one or more cooling or heating hardware elements of the electric vehicle includes activating a defrosting element of the electric vehicle to defrost a windshield or side-view mirror of the electric vehicle.

9. The method of claim 1, wherein activating one or more cooling or heating hardware elements of the electric vehicle includes activating a seat warmer or seat cooler to heat or cool a driver or passenger seat inside the electric vehicle.

10. The method of claim 1, wherein activating one or more cooling or heating hardware elements of the electric vehicle includes activating a steering wheel warmer or cooler to heat or cool a steering wheel of the electric vehicle.

11. The method of claim 1, wherein activating the one or more cooling or heating hardware elements of the electric vehicle to reach the desired climatic setting includes heating or cooling either an entire inside cabin of the electric vehicle or heating and cooling a particular object or climatic zone of the electric vehicle.

12. The method of claim 11, wherein the object to be heated or cooled includes a steering wheel.

13. The method of claim 11, wherein the object to be heated or cooled includes a driver or a passenger seat.

14. The method of claim 11, wherein the climatic zone is a specific portion of an inside cabin of the electric vehicle.

15. The method of claim 14, wherein the climatic zone includes the front driver and passenger seat area inside the cabin of the electric vehicle.

16. The method of claim 14, wherein the climatic zone includes the seats behind the front driver and passenger seat area inside the cabin of the electric vehicle.

17. The method of claim 1, wherein selecting the charging option based on one or more factors includes selecting based on peak times, wherein the cost is higher during a high peak time than a non-peak time.

18. The method of claim 1, wherein selecting the charging option based on one or more factors include selecting a hybrid charging option that includes charging a part of the charge during a non-peak time and charging the other part of the charge during a peak time.

19. The method of claim 1, wherein selecting the charging option based on one or more factors includes selecting a charging option based on costs per kilowatt.

20. The method of claim 19, wherein selecting a charging option is based on the lowest cost per kilowatt.

21-29. (canceled)
